(19) United States
(12) Patent Application Publication
(10) Pub. No.: US 2004/0199612 A1
(43) Pub. Date: Oct. 7, 2004

(54) Apparatus and method for resetting Node-B's number in mobile communication system

(76) Inventor: Hyun-Jung Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/720,111

(22) Filed: Nov. 25, 2003

(30) Foreign Application Priority Data
Feb. 13, 2003 (KR) 2003-8986

(51) Int. Cl. G06F 15/177

(52) U.S. Cl. 709/220

(57) ABSTRACT

A system and method for updating a Node-B's number in a mobile communication system. The system and method update a processor loading data (PLD) without interrupting a mobile communication service when there is a need for a Node-B's number to be updated in the mobile communication system. The PLD to be updated is created by a URM (UMTS Radio Manager), and the created PLD is transmitted to a Node-B or RNC (Radio Network Controller) requiring the created PLD. After receiving the created PLD, the Node-B and the RNC perform a system reset operation using the received PLD other than pre-stored PLD, resulting in a reduction in a service interruption time.

### PRIORITY

This application claims priority to an application entitled “APPARATUS AND METHOD FOR RESETTING NODE-B'S NUMBER IN MOBILE COMMUNICATION SYSTEM”, filed in the Korean Intellectual Property Office on Feb. 13, 2003 and assigned Serial No. 2003-8986, the contents of which are hereby incorporated by reference.

### BACKGROUND OF THE INVENTION

1. Field of the Invention

The present invention relates to an apparatus and method for updating a Node-B's number in a mobile communication system, and more particularly to an apparatus and method for updating processor loading data (PLD) without interrupting the mobile communication service.

2. Description of the Related Art

Typically, a code division multiple access (CDMA) system has a large number of users depending on the wireless environment, and that neighboring systems are greatly affected when there is a change in system resources. Therefore, a variety of methods for minimizing the influence of the CDMA system upon the neighboring systems are needed. A typical communication system performs a call connection between a specific subscriber and another subscriber using a switching process. In performing the switching process, the communication system includes a unique database (DB) for every processor and interconnects and manages a plurality of subscribers using such unique DBs for every processor. Although there may be data available only for a specific processor in various data stored in such DBs, most of the data is commonly interoperable with other processors. If data associated with a specific processor from among commonly-used data (also called common data) is updated with another data, data associated with other processors must be simultaneously updated. For example, if data associated with a handover function of a specific Node-B is updated, both the data stored in a radio network controller (RNC) managing the Node-B and the handover-associated data stored in neighboring RNCs performing the handover function must be updated at the same time. If there is a need for the commonly-used data to be updated while the communication system is operating, the commonly-used data in the processors must be updated with another data without interrupting the system.

FIG. 1 is a block diagram of a conventional mobile communication system. In FIG. 1, the conventional mobile communication system includes a universal mobile telecommunications system (UMTS) radio manager (URM) 102, a global asynchronous transfer mode (ATM) switch network (GAN or RCSI) 103, a plurality of radio network controllers (RNCs) 104, and a plurality of Node-Bs 105. The GAN 103, the RNCs 104, and the Node-Bs 105 are called network elements, respectively The Node-Bs 105 perform an interface function between user equipments (UEs) 107. The RNCs 104 are positioned between a mobile switching center (MSC) 106 and the Node-Bs 105, and control a maximum of 64 Node-Bs. The RNCs 104 perform a variety of functions, for example, UE's location registration, service access, call and session control, real-time traffic process, handoff process, network management, and MSC interface, among other functions. The GAN 103 is an ATM switch, is positioned between the URM 102 and the RNCs 104, provides the RNCs 104 with a variety of functions associated with a permanent virtual channel and a switched virtual channel, provides quality of service (QoS) related information such as a constant bit rate and a variable bit rate, among other types, and performs a network management function such as a traffic management, among other network management functions The GAN 103 contains a DS-E1 (2.048 Mbps) transfer interface to interface with the Node-Bs 105, and provides UTP25 (25.6 Mbps) and UTP155 (155.520 Mbps) interface ports to interface with individual units contained in the RNCs 104.

The operator terminal 100 commands the URM 102 to determine whether replicated data stored in the URM 102 is equal to other replicated data stored in the network elements 103, 104, and 105. The URM 102 stores data associated with the network elements 103, 104, and 105. In this case, the term data refers processor loading data (PLD). The PLD is infrequently updated static data, for example, hardware format information, information resources, loading table, system constants, and so on. The PLD is stored in a predetermined region of a main memory independently from a program in order to perform a real-time process, and is based on an entity-relationship model in the form of a table. The PLD is defined differently according to hardware format, capacity, and operation data of the Node-B. The network elements 103, 104 and 105 store unique PLDs, respectively

In the conventional mobile communication system, both the PLD stored in a specific Node-B 105, and other PLDs stored in the RNCs 104 related to the specific Node-B and the URM 102 must be updated at the same time. If a Node-B is installed to update network configuration of a system in use, the PLD of the RNCs 104 managing the Node-B must be updated, or the system in use by a specific RNC must physically move to another RNC. In the case of updating an identifier (ID) of the Node-B, the PLDs of associated RNCs and the PLD of a corresponding Node-B must be updated simultaneously.

FIG. 2 is a flow chart illustrating a PLD update process of all the systems associated with a specific Node-B when the PLD associated with the specific Node-B is updated in a conventional mobile communication system. The conventional PLD update process will hereinafter be described with reference to FIG. 2.

Referring to FIG. 2, the mobile communication system begins the process of updating the PLD associated with the RNC and the Node-Bs at step 210. If the PLD associated with the RNC and the Node-B is to be updated, the mobile communication system interrupts operations of all nodes contained in the mobile communication system. There are a plurality of cases where the PLD is updated. For example, a PLD associated with the RNC can be updated, and a PLD associated with the Node-B can also updated. However, FIG. 2 shows only one exemplary case wherein the PLD associated with the Node-B is updated.

In step 212, the URM 200 generates the PLD to be updated. A plurality of cases when the PLD is updated will hereinafter be described. The URM 200 generates an updated PLD associated with the specific Node-B denoted by a destination Node-B 204 in FIG. 2. If the PLD of the destination Node-B 204 is updated, the PLD of Node-Bs and RNCs associated with the destination Node-B 204 must also be updated. The destination RNC 202 and the neighbor RNC 206 serving as elements to be updated are shown in FIG. 2. Therefore, the URM 200 updates the PLD to be transmitted to the destination RNC 202, the destination Node-B 204, and the neighbor RNC 206. It should be noted that individual elements have different PLDs and a variety of PLDs suitable for the elements are updated.

After creating the new PLD in step 212, the URM 200 transmits the updated PLD associated with the destination Node-B 204 to the RNC 202 managing the destination Node-B 204 in step 214. The RNC managing the destination Node-B 204 is denoted by the destination RNC 202 in FIG. 2. The destination RNC 202 stores the updated PLD transferred from the URM 200.

Following transmission of the newly updated PLD from the URM to the destination RNC 202 in step 214, the URM 200 transmits the updated PLD to the destination Node-B 204 in step 216. The destination Node-B 204 stores the updated PLD transferred from the URM 200.

The URM 200 then transmits the updated PLD to the neighbor RNC 206 in step 218. The neighbor RNC 206 is a predetermined RNC other than the destination RNC 202. The reason why the updated PLD is transmitted to the destination RNC 206 will now be described. Provided that the PLD associated with the destination Node-B, for example, handover-related data, etc., affects the neighbor RNC 206, the PLD stored in the neighbor RNC 206 must also be updated.

Although steps 210 to 222 are classified into three stages in FIG. 2, these three stages can be unified into a single stage. The updated PLD can be transferred over either a wired communication network or a wireless communication network.

In step 220, the URM 200, the destination RNC 202, the destination Node-B 204, and the neighbor RNC 206 perform system loading so as to apply transmitted update PLD to individual systems. Although there is no URM PLD update process in FIG. 2, the URM 200 performs an update process for its own PLD. By executing steps 214 through 220, the old PLD previously stored is updated with the newly-transmitted PLD such that the newly-transmitted PLD is stored. System loading is then performed by the stored PLD. The mobile communication system resets the system by means of the updated PLD in step 222.

Therefore, provided that the PLD is updated with another PLD as stated above, there is then a need for the updated PLD to be applied to the mobile communication system and the mobile communication service must be unexpectedly interrupted for a specific period of time. Thus, while the old PLD is updated with the new PLD, the mobile communication service is interrupted while resetting the mobile communication system. A long period of time, for example, 10 to 20 hours, can be consumed for updating the PLD,.

Thus, an improved method must be developed for updating the PLD and resetting a system using the updated PLD within a predetermined range with little or no mobile communication service interruption, and another method must also be developed for updating the PLD even though mobile communication service has been interrupted. Furthermore, the duration of time consumed for resetting the system using the updated PLD must be reduced.

### SUMMARY OF THE INVENTION

Therefore, the present invention has been made in view of the above problems, and it is an object of the present invention to provide an apparatus and method for resetting a PLD without interrupting a mobile communication service, when a Node-B's number is reset or updated in a mobile communication system. It is another object of the present invention to provide an apparatus and method for finding only data different from a previously set-up PLD when resetting a Node-B's number in a mobile communication system, and resetting or updating the PLD using the found data.

It is yet another object of the present invention to provide an apparatus and method for reducing a service interruption time of a mobile communication system, and resetting or updating a PLD, resulting in greater convenience for a user or operator.

In accordance with an embodiment of the present invention, the above and other objects can be accomplished by a method for updating identifier (ID) information of a Node-B, and resetting a UMTS radio manager (URM) system using the updated ID information of the Node-B in the URM system which manages the Node-B and a predetermined number of radio network controllers (RNCs) each containing a source RNC. The method comprises the steps of having the URM system create a processor loading data (PLD) of the Node-B to be changed, and transmitting the created PLD to the Node-B and the RNCs each of which contains the source RNC requiring the created PLD. The method further comprises having the Node-B and the RNCs receive the PLD to compare their pre-stored PLD with the received PLD, and updating only the part that is different the pre-stored PLD and the received PLD. The method also comprises resetting the Node-B and the RNCs upon receipt of the updated PLD.

Another aspect of the present invention provides an apparatus for updating ID (Identifier) information of a Node-B, and resetting a URM (UMTS Radio Manager) system using the updated ID information of the Node-B in the URM system which manages the Node-B and a predetermined number of RNCs (Radio Network Controllers) each containing a source RNC. The apparatus comprises the URM system for creating PLD (Processor Loading Data) of the Node-B to be changed, and for transmitting the created PLD to the Node-B and the RNCs each containing the source RNC requiring the created PLD; and the Node-B and the RNCs each for comparing pre-stored PLD with the received PLD, for updating only a different part between the pre-stored PLD and the received PLD, and for resetting the system using the updated PLD.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional mobile communication system;

FIG. 2 is a flow chart illustrating a conventional PLD update process;

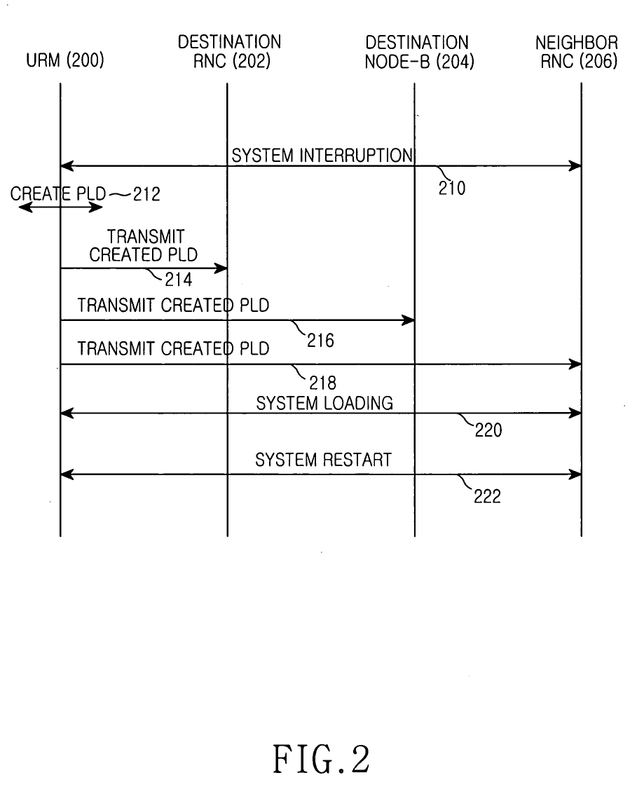

FIG. 3 is a conceptual diagram illustrating a method for increasing or decreasing the number of Node-Bs in accordance with a preferred embodiment of the present invention;

FIG. 4 is a flow chart illustrating the GROW process shown in FIG. 3 in the PLD update process in accordance with a preferred embodiment of the present invention;

FIG. 5 is a flow chart illustrating the DEGROW process shown in FIG. 3 in the PLD update process in accordance with a preferred embodiment of the present invention; and

FIG. 6 is a flow chart illustrating the DEACT process contained in the PLD update process in accordance with a preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following, a detailed description of known functions and configurations incorporated herein will be omitted when it may make the subject matter of the present invention rather unclear.

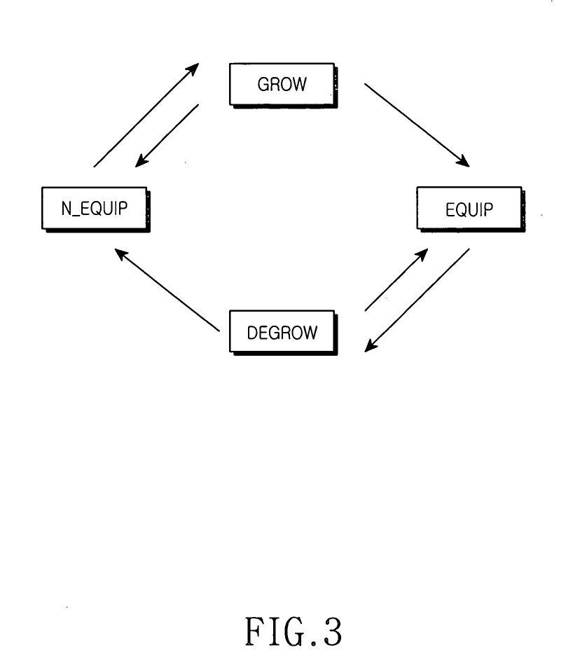

FIG. 3 is a conceptual diagram illustrating a method for increasing or decreasing the number of Node-Bs in accordance with a preferred embodiment of the present invention. The method for increasing or decreasing the number of Node-Bs will hereinafter be described with reference to FIG. 3.

There are a plurality of modes in the block diagram of FIG. 3. These include, for example, a GROW mode, an EQUIP mode, an N_EQUIP mode, and a DEGROW mode. These modes processes will hereinafter be described in greater detail.

1) EQUIP Mode:

The EQUIP mode of a processor or device is packaged in hardware such that the EQUIP mode is made available at any time by means of PLD. If the DEGROW mode is executed in the EQUIP mode, the number of Node-Bs can be decreased.

2) N_EQUIP Mode:

The N_EQUIP mode of a processor or device is not packaged in hardware such that it indicates a service disable state. In the N_EQUIP mode, the number of Node-Bs can be increased.

3) GROW Mode:

A system to be extended can contain the GROW mode. In the GROW mode, a loading function, a state function, and a failure/format management function are normally executed. A call service, however, is not supported. The GROW mode can preferably be executed to extend the system as shown in FIG. 3. The DEACT command is adapted to cancel the GROW mode.

4) DEGROW Mode:

The DEGROW mode is basically equal to the GROW mode. There are, however, some differences between the DEGROW mode and the GROW mode. The DEGROW mode continuously executes a call control process that has been executed in the EQUIP mode.

The mobile communication system adapts PLD configuration to use the modes (i.e., GROW and DEGROW) for increasing and decreasing the number of Node-Bs. Previously-setup data (i.e., old data) and updated data according to the GROW and DEGROW modes are configured in the form of an extension specification file (ESF), and are loaded in the system. The system updates data upon receiving the ESF from a man-machine-command (MMC), resulting in a minimal number of errors caused when updating data associated with the GROW and DEGROW modes.

In the case of an increasing number of RNCs or Node-Bs, the PLD copies the old PLD, and the copied old PLD controls individual IDs of the RNC and the Node-B. The PLD for controlling the IDs of the RNC and the Node-B generates a new PLD suitable for format information of a newly-installed system by referring to a standard PLD. The ESF is a kind of specification file for updating the PLD. The ESF file receives hardware format information associated with the newly-installed system from an operator. In this case, the hardware format information is entered by the operator as an MMC. The ESF file creates data to be updated for every relation upon receipt of the received format information, and creates an ESF header and an ESF directory from the created associated data. The ESF contains not only current data, but also old data at the same time, such that a data recovery process is made available without creating undesired errors caused when updating a PLD using the ESF. The ESF is also made available without additional operations when canceling the above methods for increasing and decreasing the number of Node-Bs.

The ESF includes an ESF header, an ESF directory, and ESF associated data. The ESF header includes data associated with ESF. The data associated with the ESF comprises, for example, a version of a corresponding ESF, classification of the ESF file, and the number of relations, among others.

The ESF directory contains relation information contained in the ESF data. The ESF directory contains two address parameters; a first entitled new_addr and a second entitled old_addr. The new_addr address parameter indicates a specified address for storing data associated with the modes for increasing and decreasing the number of Node-Bs. The old_addr address parameter indicates a specified address for storing data needed for data restoration when increasing or decreasing the number of Node-Bs. The ESF relation data is data to be actually updated in the PLD. The URM receives the MMC to apply data needed for the methods for increasing and decreasing the number of Node-Bs to a proper location. If the PLD is needed according to the received data, the URM creates a corresponding PLD, and also creates an associated ESF using the newly created PLD.

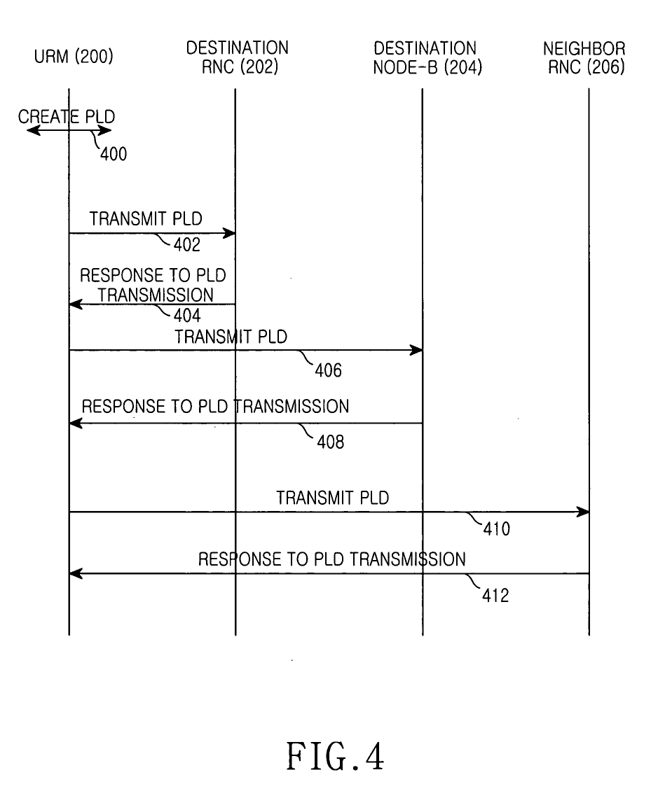

The method for updating the PLD using the newly-installed Node-B and the method for creating the ESF needed for updating the PLD according to the aforementioned methods for increasing and decreasing the number of Node-Bs will hereinafter be described. The conventional method for increasing/decreasing the number of Node-Bs is classified into four stages. The method, however, in accordance with an embodiment of the present invention for increasing/decreasing the number of Node-Bs, is classified into three stages. The three stages are a GROW stage, a DEGROW stage, and a DEACT stage. The GROW stage, the DEGROW stage, and the DEACT stage are unified into a single stage upon receipt of the operator's command, and thereby are successively executed as a single process. A process for resetting the PLD in a mobile communication system will hereinafter be described with reference to FIGS. 4 to 6. The PLD reset process according to an embodiment of the present invention will hereinafter be described with reference to FIG. 4.

As discussed above, if a Node-B is installed (the “object” node-B) to update the network configuration of a system in use, the PLD of an RNC managing the installation of the object Node-B must be updated, or the system-in-use by a specific RNC must physically move to another RNC. In the case of updating an identifier (ID) of the Node-B, not only the PLDs of the associated RNCs must be updated simultaneously and but the PLD of a corresponding Node-B must be updated as well. In the case of updating the PLD associated with the corresponding Node-B (i.e., destination Node-B), the PLD to be updated must be created.

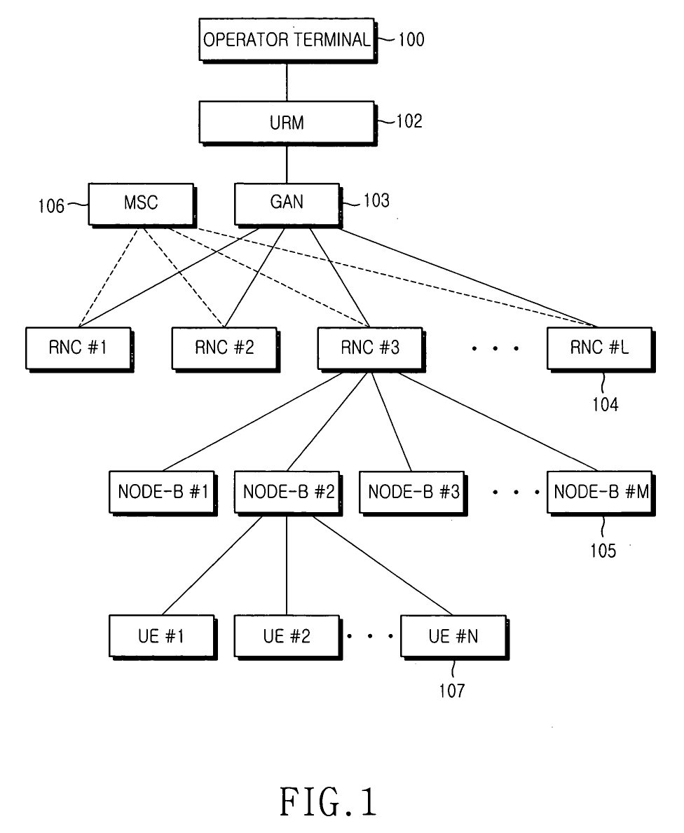

The PLD creation process is executed by the operator, as described above. The PLD creation process begins upon receipt of a predetermined signal from the operator, whereupon the URM 200 copies an old PLD to create a new PLD to be updated. Referring to FIG. 4, the PLD creation process is configured in the form of an ESF file as stated above. The URM 200 creates the PLD at step 400. Although the PLD can be preferably created by the URM 200, as shown in FIG. 4, it should be noted that the PLD can be created by the operator in the operator terminal 100 shown in FIG. 1, and the created PLD can then be transmitted to the URM 200. The created PLD is created by correcting only data that is different from the previously-stored PLD. The URM 200 creates only the changed PLD, instead of creating all the PLDs.

The URM 200 converts the created PLD into an ESF at step 402. The converted ESF is transferred to an RNC (i.e., destination RNC) 202 managing the Node-B where the PLD must be updated. The destination RNC 202 stores the ESF transferred from the URM 200.

The destination RNC 202 transmits a response message to the URM 200 at step 404. Upon receiving the response message from the destination RNC 202, the URM 200 can determine whether the destination RNC 202 has received the ESF. If the response message is not received from the destination RNC 202 before a predetermined period of time elapses, the URM 200 attempts to retransmit the ESF. The step of a repeated transmission is not shown in FIG. 4, as the ESF was accurately transferred from the destination RNC 202 to the URM 200.

The URM 200 again converts the created PLD into an ESF in step 406 and transmits it to the destination Node-B 204 where the PLD update process is required. The destination Node-B 204 stores the ESF received from the URM 200.

The destination Node-B 204 transmits a response message to the URM 200 in step 408. Upon receiving the response message from the destination Node-B 204, the URM 200 can determine whether the destination Node-B 204 has received the ESF. If the response message is not received from the destination Node-B 204 before a predetermined period of time elapses, the URM 200 attempts to retransmit the ESF. As shown in FIG. 4, the ESF is accurately transferred from the destination Node-B 204 to the URM 200, and retransmission of the ESF is not attempted.

The URM 200 again converts the created PLD into an ESF in step 410, and transmits the ESF to the neighbor RNC 206 affected by an update process of the PLD associated with the destination Node-B 204. There are a variety of reasons why the PLD associated with the neighbor RNC 206 must be updated. One example is a handover factor. The neighbor RNC 206 stores the ESF received from the URM 200.

The neighbor RNC 206 transmits the response message to the URM 200 in step 412. Upon receiving the response message from the neighbor RNC 206, the URM 200 can determine whether the neighbor RNC 206 has received the ESF. If the response message is not received from the neighbor RNC 206 before a predetermined period of time elapses, the URM 200 attempts to retransmit the ESF. As shown in FIG. 4, the ESF is accurately transferred from the neighbor RNC 206 to the URM 200, and retransmission of the ESF is not attempted. Steps 402, 406 and 410 can be unified into a single step, and steps 404, 408, and 412 can also be unified into a single step.

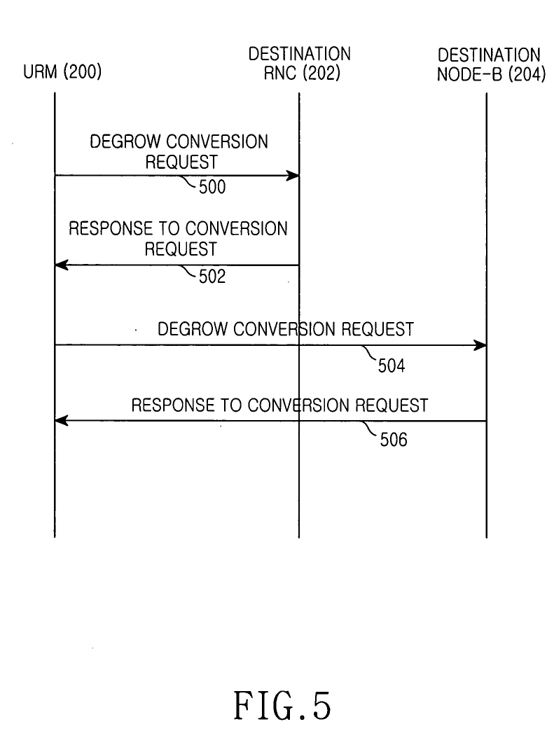

If the GROW mode is executed in steps 400˜412 in the mobile communication system, the DEGROW process is also executed. The DEGROW mode will hereinafter be described with reference to FIG. 5.

Referring to FIG. 5, the URM 200 requests that the destination RNC 202 enter the DEGROW mode in step 500. A detailed description of the DEGROW mode was previously discussed for the convenience of description of the embodiments of the present invention. Upon receiving the DEGROW entry request from the URM 200, the destination RNC 202 transmits a response to the DEGROW entry request to the URM 200 in step 502.

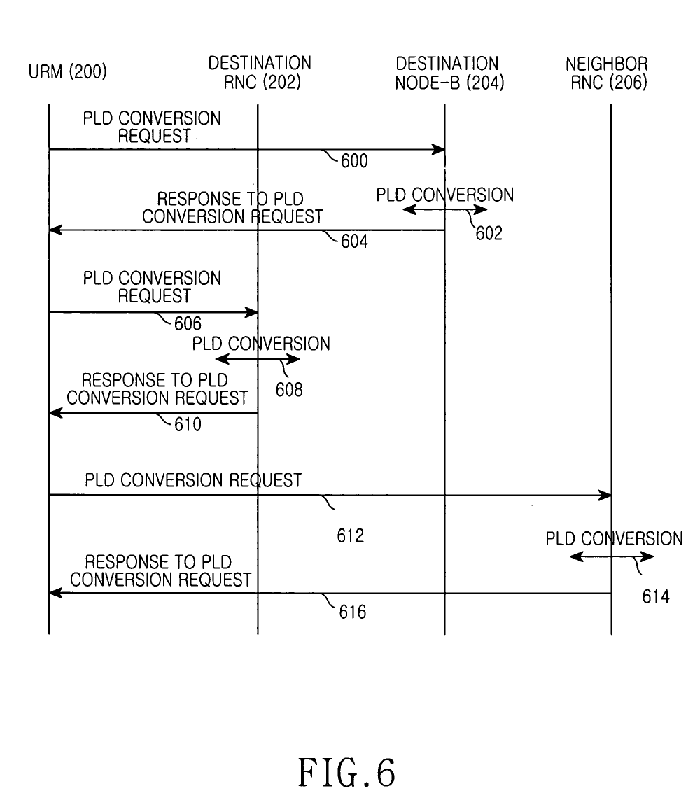

The URM 200 requests that the destination Node-B 204 enter the DEGROW mode in step 504. The DEGROW mode was previously discussed for the convenience of description of the embodiments of the present invention. Upon receiving the DEGROW entry request from the URM 200, the destination Node-B 204 transmits a response to the DEGROW entry request to the URM 200 in step 506. Steps 500 and 504 can be unified into a single step, and steps 502 and 506 can also be unified into a single step. If the mobile communication system executes the DEGROW mode in steps 500˜506, the DEACT mode, serving as the last process of the embodiments of the present invention to be discussed, is executed. The DEACT mode will hereinafter be described with reference to FIG. 6.

Referring to FIG. 6, in step 600, the URM 200 requests that the destination Node-B 204 update the old PLD which was previously stored and operated in connection with the destination Node-B 204 and the new PLD transferred in the GROW mode. Upon receiving the PLD update request from the URM 200 in step 600, the destination Node-B 204 updates the PLD at step 602. In the case of updating the PLD, the destination Node-B 204 updates only data that is different from the previously-stored PLD and does not update data identical to data in the previously-stored PLD. During the PLD update process, the destination Node-B 204 temporarily interrupts all operations, and then resets the hardware. By performing these processes, the hardware system of the destination Node-B 204 is reset by the new PLD rather than the old PLD that was previously stored. The destination Node-B 204 transmits a response to the PLD update request that was transmitted in step 600 to the URM 200 in step 604. This response means that the stored PLD has been updated per the PLD update request of the URM 200.

If the PLD update process for the destination Node-B 204 is completed, the URM 200 requests that the destination RNC 202 update the old PLD in step 606 which was previously stored and operated in connection with the destination RNC 202, with the new PLD transferred in the GROW mode. Upon receiving the PLD update request from the URM 200 in step 606, the destination RNC 202 updates the PLD in step 606. The destination RNC 202 compares the previously-stored PLD (i.e., the old PLD) with the received PLD (i.e., the new PLD) in the PLD reset process, and corrects only the data that is different between the old and new PLDs according to the result of the comparison, because the URM 200 transmits the PLD in the form of an ESF. The ESF stores data associated with the data that is different between the old and new PLDs. By performing the aforementioned processes, the previously-stored PLD is updated by the PLD transferred from the URM 200. The destination RNC 202 transmits a response to the PLD update request in step 610 which was previously performed in step 606 to the URM 200. This response means that the stored PLD has been updated per the PLD update request of the URM 200.

The URM 200 requests that the neighbor RNC 206 update the old PLD in step 612 which was previously stored and operated in connection with the neighbor RNC 206 with new PLD transferred in the GROW mode. Upon receiving the PLD update request from the URM 200 in step 606, the neighbor RNC 206 updates the PLD in step 614. The neighbor RNC 206 compares the previously-stored PLD (i.e., the old PLD) with the received PLD (i.e., the new PLD) in the PLD update process, and corrects only data that is different between the old and new PLDs according to the result of the comparison, because the URM 200 transmits the PLD in the form of an ESF. The ESF stores data associated with the data that is different between the old and new PLDs. By performing the aforementioned processes, the previously-stored PLD is updated by the transferred PLD. The neighbor RNC 206 transmits a response to the PLD update request performed in step 612, to the URM 200 in step 616. This response means that the stored PLD has been updated per the PLD update request of the URM 200. Steps 606 and 612 can be unified into a single step, and steps 610 and 616 can also be unified into a single step.

As apparent from the above description, the embodiments of the present invention provide an apparatus and method for updating the PLD without interrupting the mobile communication service when a Node-B's number is reset or updated in a mobile communication system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for updating identifier (ID) information of a Node-B, and resetting a UMTS radio manager (URM) system using the updated ID information of the Node-B in the URM system which manages the Node-B and a predetermined number of radio network controllers (RNCs) each containing a source RNC, said method comprising:
a) using the URM system to create a processor loading data (PLD) of the Node-B that can be changed, and transmitting the created PLD to the Node-B and the RNCs each of which contains the source RNC requiring the created PLD;
b) operating the Node-B and the RNCs having received the PLD to compare their, and updating only a difference part between the pre-stored PLD and the received PLD; and
c) resetting the Node-B and the RNCs upon receipt of the updated PLD.

2. The method as set forth in claim 1, further comprising:
d) operating the Node-B and the RNCs to transmit a response to a PLD reception operation in the URM system after the node-B and the RNCs have received the PLD.

3. The method as set forth in claim 2, further comprising the step of:
e) resetting the Node-B using the updated PLD, and then resetting the RNCs using the updated PLD.

4. The method as set forth in claim 3, further comprising:
operating the Node-B and the RNCs to reset the system using the updated PLD and informing the URM system of a reset completion state of the URM system using the updated PLD.

5. The method as set forth in claim 1, wherein the created PLD contains information associated with changed data from among a plurality of PLDs stored in the Node-B and the RNCs.

6. An apparatus for updating ID (Identifier) information of a Node-B, and resetting a URM (UMTS Radio Manager) using the updated ID information of the Node-B in the URM system which manages the Node-B and a predetermined number of RNCs (Radio Network Controllers) each containing a source RNC, said apparatus comprising:
the URM system for creating PLD of the Node-B to be changed, and transmitting the created PLD to the Node-B and the RNCs each containing the source RNC requiring the created PLD; and
the Node-B and the RNCs each for comparing pre-stored PLD with the received PLD, updating only a different part between the pre-stored PLD and the received PLD, and resetting the system using the updated PLD.

7. The apparatus as set forth in claim 6, wherein the Node-B and the RNCs receive the PLD, and transmit a response to a PLD reception operation to the URM system.

8. The apparatus as set forth in claim 7, wherein the RNCs reset the Node-B using the updated PLD, and then reset the system using the updated PLD.

9. The apparatus as set forth in claim 8, wherein the Node-B and the RNCs reset the system using the updated PLD, and inform the URM system of a reset completion state of the system using the updated PLD.

10. The apparatus as set forth in claim 6, wherein the URM system creates the PLD containing information associated with changed data from among a plurality of PLDs stored in the Node-B and the RNCs.

11. A method for adding a node-B in a mobile communication system, wherein the mobile communication system comprises a UMTS radio manager (URM) and at least one radio network controller (RNC), and wherein the method comprises:
performing the following steps without interrupting mobile communication service in the mobile communications network:
storing new processor loading data (PLD) at an RNC which is associated with the Node-B being added; and
storing the new PLD at the Node-B.

12. The method according to claim 11, further comprising:
storing the new PLD at an RNC neighboring the RNC which is associated with the node-B being added without interrupting the mobile communication service.

13. The method according to claim 11, wherein the step of storing the new processor loading data (PLD) at the RNC comprises:
creating the processor loading data (PLD) at the URM;
converting the PLD to an extension specification file (ESF) at the URM;
transmitting the ESF from the URM to the RNC;
receiving the ESF transmitted by the URM at the RNC; and
storing the ESF transmitted by the URM at the RNC.

14. The method according to claim 13, further comprising:
receiving at the URM a transmitted response message from the RNC within a predetermined period of time indicating receipt of the ESF transmitted by the URM.

15. The method according to claim 13, further comprising:
transmitting repeatedly the ESF from the URM to the destination RNC until the transmitted response message from the RNC indicating receipt of the ESF transmitted by the URM within a predetermined period of time has been received by the URM.

16. The method according to claim 11, wherein the step of storing the new PLD at the Node-B comprises:
creating a processor loading data (PLD) at a URM;
converting the PLD to an extension specification file (ESF) at the URM;
transmitting the ESF from the URM to the Node-B being added;
receiving the ESF transmitted by the URM at the Node-B being added; and
storing the ESF transmitted by the URM at the Node-B being added.

17. The method according to claim 16, further comprising:
receiving at the URM a transmitted response message from the Node-B being added indicating receipt of the ESF transmitted by the URM within a predetermined period of time.

18. The method according to claim 16, further comprising:
transmitting repeatedly the ESF from the URM to the Node-B being added until the transmitted response message from the Node-B being added indicating receipt of the ESF transmitted by the URM within a predetermined period of time has been received by the URM.

19. The method according to claim 12, wherein the step of storing the new processor loading data (PLD) at the neighboring RNC comprises:
creating a processor loading data (PLD) at a URM;
converting the PLD to an extension specification file (ESF) at the URM;
transmitting the ESF from the URM to the neighboring RNC;
receiving the ESF transmitted by the URM at the neighboring RNC; and
storing the ESF transmitted by the URM at the neighboring RNC.

20. The method according to claim 19, further comprising:
receiving at the URM a transmitted response message from the neighboring RNC indicating receipt of the ESF transmitted by the URM within a predetermined period of time.

21. The method according to claim 19, further comprising:
transmitting repeatedly the ESF from the URM to the neighboring RNC until the transmitted response message from the neighboring RNC indicating receipt of the ESF transmitted by the URM within a predetermined period of time has been received by the URM.
